(19) United States
(12) Patent Application Publication
(10) Pub. No.: US 2006/0059281 A1
(43) Pub. Date: Mar. 16, 2006

(54) Image forming apparatus and data-leakage prevention program

(76) Inventors: Norio Michiie, Tokyo (JP); Hiromitsu Shimizu, Tokyo (JP); Yuriko Obata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/222,778

(22) Filed: Sep. 12, 2005

(30) Foreign Application Priority Data
Sep. 16, 2004 (JP) 2004-270239

(51) Int. Cl. G06F 3/06

(52) U.S. Cl. 710/59

(57) ABSTRACT

A writing unit writes received image data into a buffer. A copying unit copies the image data from the buffer to a storing unit. A control unit controls the copying unit so as to stop copying of the image data from the buffer to the storing unit, and erases the image data from the buffer when, for example, a stop instruction is received.

### CROSS-REFERENCE TO RELATED APPLICATIONS

The present document incorporates by reference the entire contents of Japanese priority document, 2004-270239 filed in Japan on Sep. 16, 2004.

### BACKGROUND OF THE INVENTION

1. Field of the Invention

The present invention relates to a technology for preventing data leaking from a buffer memory.

2. Description of the Related Art

A composite machine that has multiple functions of a printer, a copier, and a scanner, is known in the art. The composite machine has a plurality of applications such as a printer application, a copier application, and a scanner application installed on a versatile operating system (OS) such as UNIX®. The multiple functions are executed by switching from one application to another.

To accommodate multiple functions, the composite machine includes an input devices and an output device. A scanner is an example of the input device and a plotter is an example of the output device. Such a composite machine typically uses a memory control technology such as direct memory access (DMA) to accelerate the processing speed. Japanese Patent Application Laid Open No. 6-103225 discloses examples of a DMA transfer method and a DMA controller.

Due to increasing needs for high-speed processing, a buffer memory is typically included in the input and output devices. By using the buffer memory, different data processings can be performed in parallel. This accelerates the overall processing speed of the composite machine. Moreover, a buffer memory of larger capacity is used to accommodate various types of data.

Furthermore, data security is a major issue in the society; particularly, leakage of data remaining in a copier and other information devices is a serious concern.

One approach is to restrict access to a hard disk device in the composite machine by applying a password. Another approach is to encrypt data stored in the hard disk device or other memory devices.

However, it is not commonplace to apply a password to a buffer memory. Even if access is restricted by applying a password, a malicious user can acquire data remaining in the buffer memory. Moreover, it is not practical to encrypt data stored in a buffer memory, because a data encryption processing slows down the processing speed of the buffer memory that is supposed to accelerate the overall processing.

In a composite machine that charges a service fee to provide a function, the function is interrupted when a failure occurs in a charging operation. It is necessary to prevent data remaining in a buffer memory from leaking when the function is interrupted.

This problem not only applies to the composite machine, but also to any information device that includes a buffer memory used for temporarily storing data.

### SUMMARY OF THE INVENTION

It is an object of the present invention to at least solve the problems in the conventional technology.

An image forming apparatus according to one aspect of the present invention includes a receiving unit configured to receive image data; a first storing unit configured to store data for a first duration; a second storing unit configured to store data for a second duration longer than the first duration; a writing unit configured to write the image data into the first storing unit; a copying unit configured to copy the image data from the first storing unit to the second storing unit; and a control unit configured to control the copying unit so as to stop copying of the image data, and erases the image data from the first storing unit when a predetermined condition is satisfied.

A method according to another aspect of the present invention includes storing image data in a first storing unit that is configured to store data for a first duration; copying the image data from the first storing unit to a second storing unit that is configured to store data for a second duration longer than the first duration; and stopping the copying and erasing the image data from the first storing unit when a predetermined condition is satisfied.

A computer-readable recording medium according to another aspect of the present invention stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a network that includes a composite machine according to an embodiment of the present invention;

FIG. 2 is a detailed block diagram of the composite machine shown in FIG. 1;

FIG. 3A is a schematic for explaining an input processing according to the embodiment;

FIG. 3B is a schematic for explaining a data erasing processing according to the embodiment;

FIG. 3C is a schematic for explaining another data erasing processing according to the embodiment;

FIG. 4 is a functional block diagram of the composite machine;

FIG. 5 is a flowchart of a processing performed by an input managing unit shown in FIG. 4;

FIG. 6 is a flowchart of a processing performed by a data processing section shown in FIG. 4 input stop instruction; and

FIG. 7 is a flowchart of another processing performed by the data processing section input stop instruction.

### DETAILED DESCRIPTION OF THE PREFERRED EMBODIMENTS

Exemplary embodiments of the present invention will be described below with reference to accompanying drawings. The present invention is not limited to these embodiments.

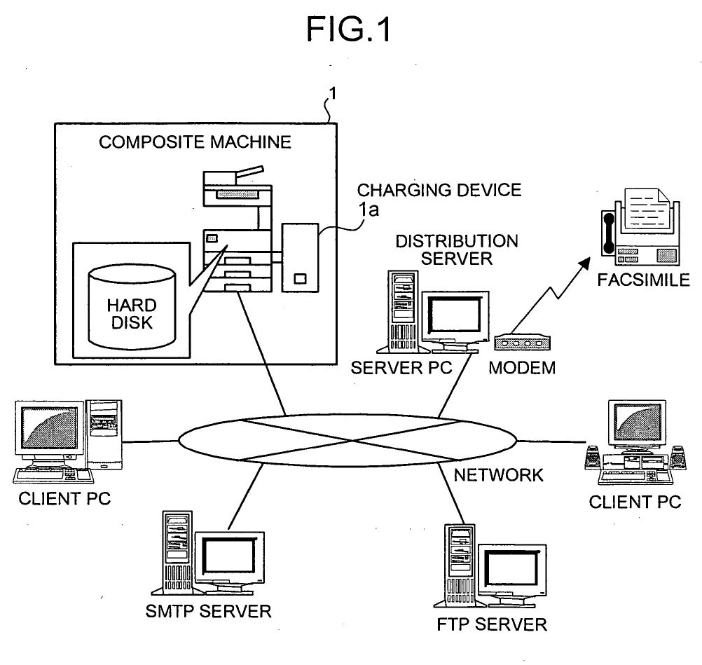

FIG. 1 is a schematic of a network that includes an image forming apparatus (hereinafter, “composite machine”) 1 according to an embodiment of the present invention.

Amidst the ongoing progress of networking, office devices such as personal computers (PC) are typically connected to a local area network (LAN) for communicating with each other. Client PCs, a simple mail transfer protocol (SMTP) server, a file transfer protocol (FTP) server, and a server PC are connected to the network in FIG. 1. These devices can exchange e-mails and files. A distribution server connected to a modem can communicate with facsimile machines outside the office.

The composite machine 1 is connected to the network, and communicates with the PCs, etc. Moreover, the composite machine 1 has a built-in memory such as a hard disk. Accordingly, the composite machine 1 can cater to various needs as a network composite machine.

The composite machine 1 can function as a regular copier; a printer that prints document data according to a print request from a client PC; a facsimile machine that transmits document data to a facsimile machine outside the office through the modem connected to the server PC according to a facsimile request from a client PC; and storing, in the hard disk, data of a facsimile document received or a document copied.

To function as above, the composite machine 1 various devices such as input devices such as a scanner, output devices such as a plotter, and input/output devices such as a hard disk. For example, the copier function is provided by the scanner and the plotter, and the storing function by the scanner and the hard disk.

Usually, data used in each of these input or output devices have different formats and units. Therefore, data input to an input device needs to be processed before being input to the composite machine 1 (e.g. image conversion), and then needs to be processed again before being passed to an output device. Moreover, output devices usually have different processing speeds, and these differences need to be absorbed. Furthermore, the overall processing speed of the composite machine 1 needs to be fast. To address these needs, input or output devices typically include a buffer memory such as a dynamic random access memory.

Therefore, data such as image data is temporarily stored in the buffer memory. When the capacity of the buffer memory is small, it is almost impossible to read image data. However, the composite machine 1 includes a buffer memory that is large enough to store about one page of data.

When data stored in the buffer memory is read by a malicious user, confidential data can be leaked. Prevention of data leakage is a major concern in the society, and standards related to data security are being established.

Prevention of data leakage is particularly important when a user is charged a fee to read or store data. Even when a password is required to access a memory, data remaining in the buffer memory can be leaked.

One approach is to prevent data leakage by encrypting the data stored in the buffer memory. However, this is not practical because a data encryption processing slows down the processing speed of the buffer memory that is supposed to accelerate the processing. Therefore, the composite machine 1 prevents data leakage by erasing the data in the buffer memory.

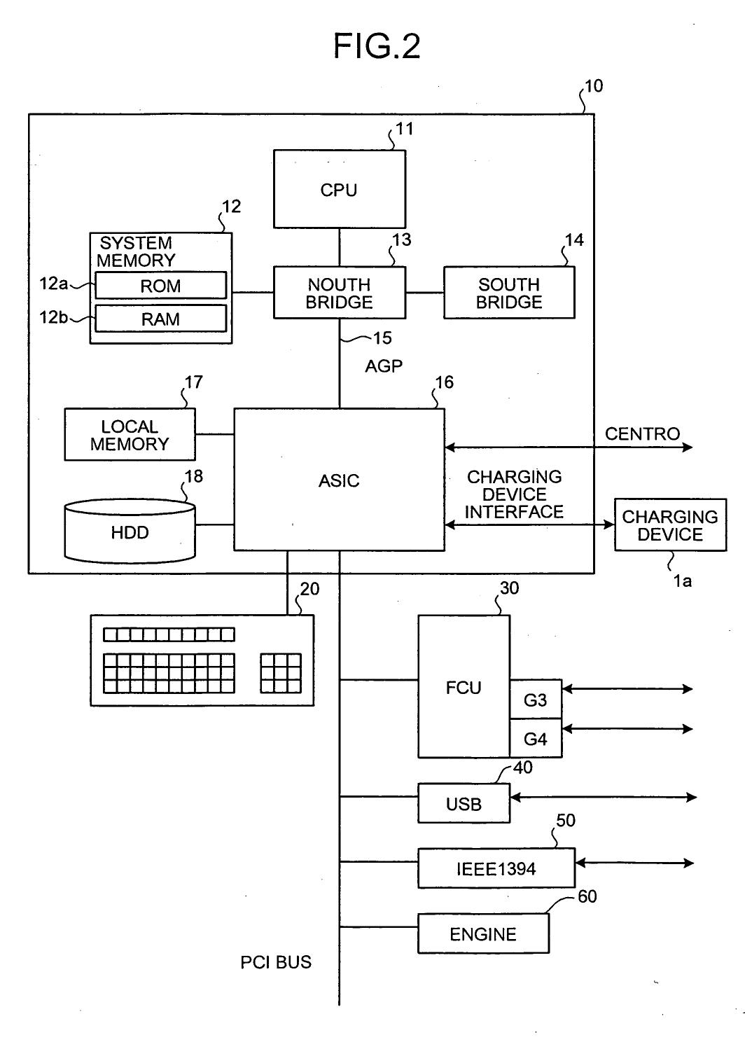

FIG. 2 is a detailed block diagram of hardware construction of the composite machine 1. The composite machine 1 includes a controller 10 and an engine 60 that are connected by a peripheral component interconnect (PCI) bus. The controller 10 controls each unit in the composite machine 1, drawing, communication, and input from an operation unit (not shown). The engine 60 is a printer engine that can be connected to the PCI bus, such as a monochrome plotter, a single-drum color plotter, a four-drum color plotter, a scanner, or a facsimile unit. The engine 60 also includes an image processing unit for performing error diffusion, gamma conversion, etc.

The controller 10 includes a central processing unit CPU 11, a north bridge 13, a system memory 12, a south bridge 14, a local memory 17, an application specific integrated circuit (ASIC) 16, and a hard disk drive (HDD) 18. The north bridge 13 and the ASIC 16 are connected by an accelerated graphics port (AGP) bus 15. The system memory 12 is a system memory including a read only memory (ROM) 12a and a random access memory (RAM) 12b.

The CPU 11 controls the entire composite machine 1, and is connected to other devices through a chip set including the north bridge 13, the system memory 12, and the south bridge 14.

The north bridge 13 is a bridge for connecting the CPU 11, the system memory 12, the south bridge 14, and the AGP 15. The north bridge 13 includes a memory controller for controlling writing/reading data in/from the system memory 12, a PCI master (not shown), and an AGP target (not shown).

The ROM 12a in the system memory 12 stores programs and data. The RAM 12b in the system memory 12 is used for both reading and writing data, such as expanding programs and data, and drawing data for the printer.

The south bridge 14 is a bridge for connecting the north bridge 13, a PCI device (not shown), and surrounding devices. The south bridge 14 is connected to the north bridge 13 by the PCI bus. A network interface (I/F) (not shown) is connected to the PCI bus.

The ASIC 16 is an integrated circuit (IC) used for image processing, and includes hardware elements of image processing. The ASIC 16 functions as a bridge connecting the AGP 15, the PCI bus, the HDD 18, and the local memory 17. The ASIC 16 includes, although not shown, an arbiter (ARB) that is the main part of the ASIC 16, a PCI target, an AGP master, a memory controller that controls the local memory 17, a plurality of direct memory access controllers (DMAC) for rotating image data with a hardware logic, and a PCI unit that transfers data between the engine 60 through the PCI bus. The ASIC 16 is connected through the PCI bus to a fax control unit (FCU) 30, a universal serial bus (USB) 40, and an institute of electrical and electronic engineers (IEEE) 1394 interface 50.

The local memory 17 is a local memory used as a buffer for storing images being copied, and codes. The HDD 18 stores image data, programs, font data, and forms.

An operation panel 20 receives input from a user, and displays data to a user. A charging device la is connected to the ASIC 16 by a charging device interface. The charging device la transfers to the CPU 11, data such as an amount of fee inserted, balance of a prepaid card, or an identification code. The charging device la performs charging execution processings such as reducing the balance of a prepaid card according to a command from the CPU 11. The charging device la corresponds to a coin rack device, a prepaid card device, or a preset key card device, etc.

The AGP 15 is a bus interface for a graphics accelerator card to accelerate graphics processings. Specifically, the AGP 15 directly accesses the system memory 12 at high throughput to accelerate the processing of a graphics accelerator card.

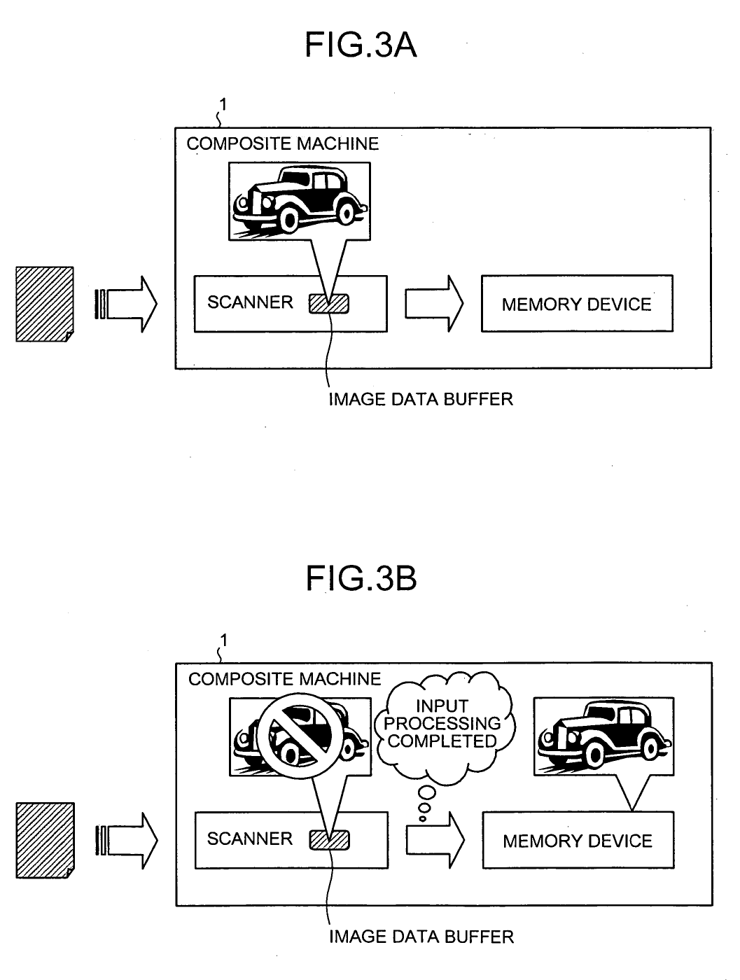

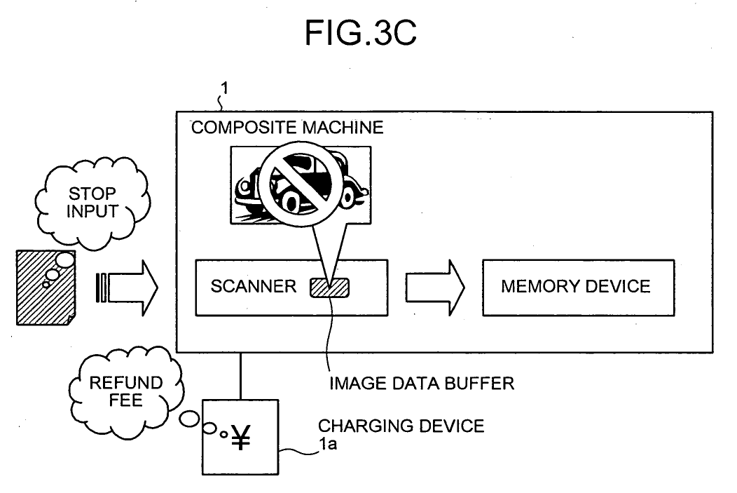

FIG. 3A is a schematic for explaining an input processing performed by the composite machine 1.

Data is read by an input device such as a scanner, and the data is stored in an input buffer used by the input device. The data is then input into a memory device such as the local memory 17. The input device performs a data conversion processing on the image data stored in the input buffer, and then inputs the converted data to the memory device. Accordingly, the composite machine 1 stores the data input to the input device into the internal memory device. The data is then passed to an output device where the data is printed onto a recording medium such as paper, and the paper is output from the composite machine 1.

In this example, the data remains in the input buffer after the data is input to the memory device. Thus, the remaining data can leak from the input buffer.

FIG. 3B is a schematic for explaining a data erasing processing in the input buffer after the input processing is completed. To prevent data leakage, the data remaining in the input buffer must be erased after the data is input to the memory device.

However, the data can still leak if the data in the input buffer is erased only after the data is input to the memory device. Specifically, when a user gives an instruction to stop the input processing, or when a user instructs the charging device 1a to refund a fee, the input processing is interrupted. As a result, the data in the input buffer is not erased, because the composite machine 1 does not detect that the data in the input buffer is input to the memory device.

FIG. 3C is a schematic for explaining a data erasing processing in the input buffer when the input processing is interrupted. Data remains in the input buffer when the input processing is interrupted. The input processing is interrupted due to a user's instruction, or a hardware error in the composite machine 1, or because a user requested a refund, or a user pulled out a prepaid card, etc. To prevent the remaining data from leaking, the data must be erased when the input processing is interrupted.

The composite machine 1 detects when data transfer in the input buffer is input to the memory device, or when the input processing is interrupted. The composite machine 1 then erases the data in the input buffer used by the input device. Accordingly, the data is prevented from leaking.

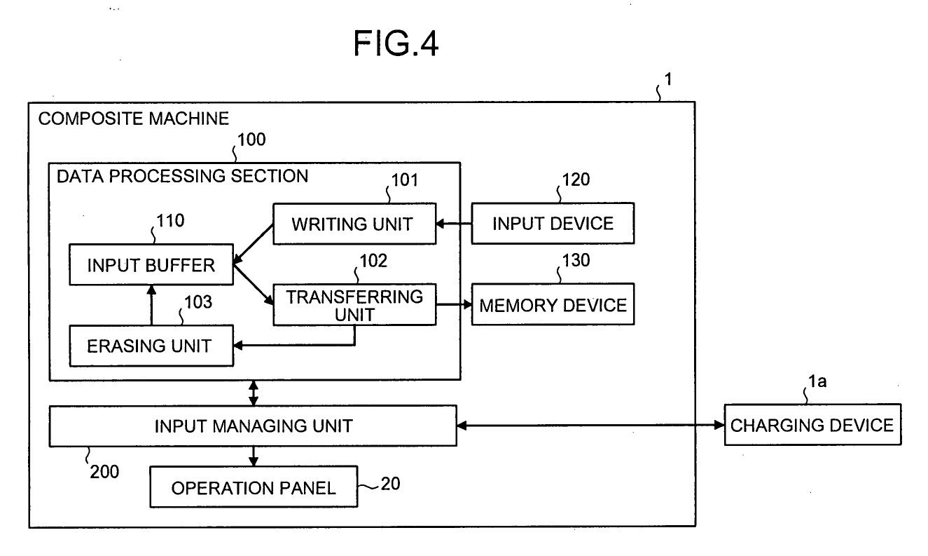

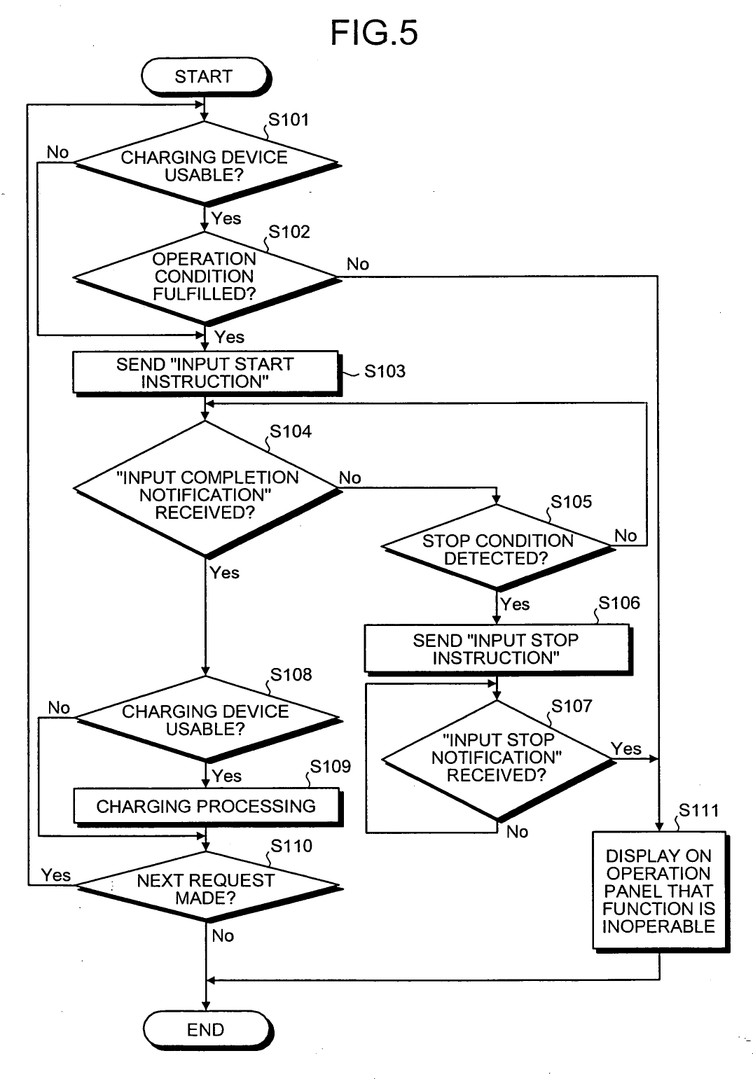

FIG. 4 is a functional block diagram of the composite machine 1. The composite machine 1 includes a data processing section 100, an input managing unit 200, an input device 120, a memory device 130, and the operation panel 20.

Data such as image data is input from the input device 120 into the data processing section 100, and the data is transferred to the memory device 130. The data processing section 100 receives an instruction message from the input managing unit 200, and sends a notification message to the input managing unit 200. The input managing unit 200 exchanges data with the charging device la, and outputs data to a user on the operation panel 20.

The data processing section 100 includes a writing unit 101, a transferring unit 102, an erasing unit 103, and an input buffer 110. The input buffer 110 is usually included inside the input device 120; however, the input buffer 110 can be provided at a part connecting the input device 120 and the composite machine 1. FIG. 4 only shows components relevant to the description of the data erasing processing.

The data processing section 100 writes data input from the input device 120 into the input buffer 110, transfers the data from the input buffer 110 to the memory device 130, and erases the data remaining in the input buffer 110.

The erasing unit 103 erases data stored in the input buffer 110 according to an instruction from the transferring unit 102. The input device 120 corresponds to, e.g. a scanner, and the memory device 130 corresponds to, e.g. the local memory 17. The input device 120 can be detachably attached to the composite machine 1 as an optional device.

The writing unit 101 receives data from the input device 120, and writes the data in the input buffer 110. The writing unit 101 starts writing the data in the input buffer 110 according to an instruction from the input managing unit 200. For example, when a user sets a paper original in the composite machine 1 and requests a copier function, data of the original is read by the input device 120. When an input start instruction is received from the input managing unit 200, the writing unit 101 writes the data read by the input device 120 into the input buffer 110.

When the input start instruction is received from the input managing unit 200, the transferring unit 102 reads data stored in the input buffer 110 and transfers the data to the memory device 130. When an input stop instruction is received from the input managing unit 200, the transferring unit 102 instructs the erasing unit 103 to erase data stored in the input buffer 110. The transferring unit 102 sends to the input managing unit 200 an input completion notification when the data transfer is completed, and an input stop notification when the data transfer is interrupted.

The memory device 130 stores the data received, and provides the data to an output device such as a plotter.

When the input stop instruction is received from the input managing unit 200, the transferring unit 102 instructs the erasing unit 103 to erase data stored in the input buffer 110. When data transfer from the input buffer 110 to the memory device 130 is completed, the transferring unit 102 instructs the erasing unit 103 to erase the data stored in the input buffer 110.

The erasing unit 103 erases data stored in the input buffer 110 after data transfer from the input buffer 110 to the memory device 130 is completed. Thus, data is prevented from remaining in the input buffer 110 after the data transfer is completed. Moreover, data is prevented from being erased from the input buffer 110 by mistake when the data transfer is not completed. Furthermore, the erasing unit 103 erases data stored in the input buffer 110 when an input stop instruction is received from the input managing unit 200. Thus, data is prevented from remaining in the input buffer 110 when the input processing is interrupted for some reason.

The input managing unit 200 acquires a status of a fee charged at the charging device la, and a status of the hardware in the composite machine 1. Based on this information, the input managing unit 200 sends an input start instruction or an input stop instruction to the data processing section 100. When an input completion notification is received from the data processing section 100, the input managing unit 200 instructs the charging device la to start charging a fee.

Specifically, when the charging device la is usable to the composite machine 1, the input managing unit 200 determines whether it is possible to charge service fees for providing a copier function etc. When there is a sufficient amount of balance, the input managing unit 200 sends an input start instruction to the data processing section 100. On the other hand, when the amount of balance is insufficient, the input managing unit 200 displays a message on the operation panel 20 that the function cannot be provided.

Moreover, the input managing unit 200 monitors the hardware status of the charging device la and the composite machine 1, detects whether the input processing is interrupted, and waits for a notification from the data processing section 100. When the input managing unit 200 detects that the input processing is interrupted, the input managing unit 200 sends an input stop instruction to the data processing section 100.

When an input stop notification is received from the data processing section 100, the input managing unit 200 displays on the operation panel 20 that the input stop notification has been received. When an input completion notification is received without receiving an input stop notification, the input managing unit 200 instructs the charging device la to start charging a fee.

The data processing section 100 reads and erases data from the input buffer 110. The input managing unit 200 monitors hardware statuses of the charging device la and the composite machine 1, and instructs the data processing section 100 to execute processings based on the hardware statuses. Thus, data can be appropriately erased from the input buffer 110, so that data is prevented from leaking from the input buffer 110.

FIG. 5 is a flowchart of a processing performed by the input managing unit 200.

The input managing unit 200 determines whether the charging device 1a is usable (step S101). The charging device 1a is not usable when it is not connected to the composite machine 1 or when it is not ON, or when it is malfunctioning. In general, the charging device la is not usable when it is in an abnormal state. When the charging device 1a is usable (Yes at step 101), the input managing unit 200 determines whether an operation execution condition for providing a function, such as a copying function, is fulfilled. The operation execution condition means that, if the charging device 1a is a key card device, the key card is set and an identification code is correct. If the charging device 1a is a prepaid card device, the operation execution condition is that the balance is equal to or more than the fee for providing the requested function.

When the operation execution condition is not fulfilled (No at step S102), the input managing unit 200 displays on the operation panel 20 that an input processing for the function cannot be performed and the reason why (step S111), and the processing ends. On the other hand, when the operation execution condition is fulfilled (Yes at step S102), or when the charging device la is not usable (No at step S101), the input managing unit 200 sends an input start instruction to the data processing section 100 (step S103).

The input managing unit 200 determines whether an input completion notification is received from the data processing section 100 (step S104). When the input completion notification is not received (No at step S104), the input managing unit 200 determines whether a stop condition for stopping the input processing is detected (step S105). The stop condition means that an input processing needs to be interrupted because a fee cannot be charged (a fee is refunded or a prepaid card is pulled out, etc.), or a hardware failure occurs in the composite machine 1.

When a stop condition is not detected (No at step S105), the system control returns to step S104, and repeats steps S104 and S105.

On the other hand, when a stop condition is detected (Yes at step S105), the input managing unit 200 sends an input stop instruction to the data processing section 100 (step S106), and waits for an input stop notification from the data processing section 100 (No at step S107). When an input stop notification is received from the data processing section 100 (Yes at step S107), the input managing unit 200 displays on the operation panel 20 that an input processing for the function cannot be performed and the reason why (step S111), and the processing ends.

When an input completion notification is received from the data processing section 100 (Yes at step S104), the input managing unit 200 determines whether the charging device la is usable (step S108). When the charging device la is usable (Yes at step S108), the input managing unit 200 performs a charging processing (step S109), and when a next request for a function is not made (No at step S110), the processing ends. When the charging device la is not usable (No at step S108), the input managing unit 200 does not perform the charging processing and proceeds to step S110. When the next request for a function is made (Yes at step S110), the steps from step S101 are repeated.

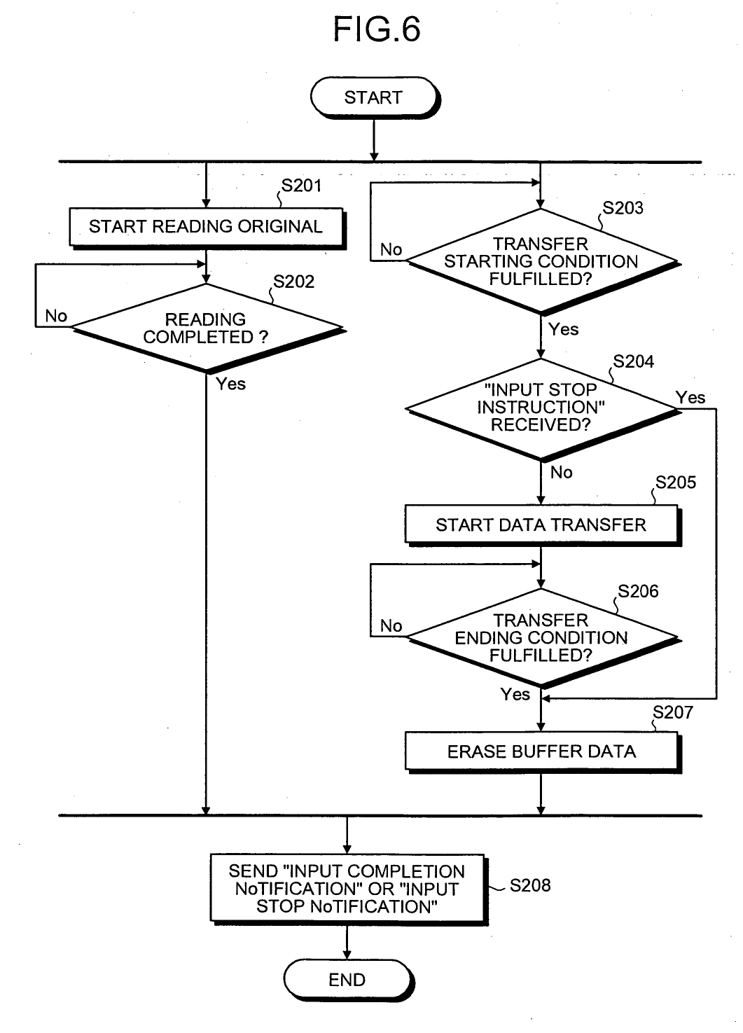

FIG. 6 is a flowchart of a processing performed by the data processing section 100. This processing is performed when the data processing section 100 receives an input stop instruction from the input managing unit 200 before data is transferred from the input buffer 110 to the memory device 130.

The data processing section 100 performs an original reading process at steps S201 to S202, and a data transfer process at steps S203 to S207 in parallel, so that the writing unit 101 and the transferring unit 102 operate at the same time. When both processes are completed, the data processing section 100 performs step S208.

The writing unit 101 reads data of an original from the input device 120, and starts writing the data into the input buffer 110 (step S201). The writing unit 101 waits until step S201 is completed (No at step S202). When step S201 is completed (Yes at step S202), the original reading process ends. Step S201 is completed when the data stored in the input buffer 110 reaches a predetermined amount.

On the other hand, the transferring unit 102 waits until a transfer starting condition is fulfilled (No at step S203). The transfer starting condition means that the original reading process starts, or the data written in the input buffer 110 reaches a predetermined amount. The transfer starting condition is set in the ROM 12a as static data, and the data processing section 100 reads the condition from the ROM 12a.

When the transfer starting condition is that original reading process has started, the writing unit 101 writes data into the input buffer 110, while the transferring unit 102 reads data from the input buffer 110 and transfers the data to the memory device 130. When the transfer starting condition is that data in written in the input buffer 110 has reached a predetermined amount, the processing is performed as follows. When data in written in the input buffer 110 reaches a predetermined amount, the transferring unit 102 reads the data from the input buffer 110 after a predetermined timing, and transfers the data to the memory device 130.

When the transfer starting condition is fulfilled (Yes at step S203), the data processing section 100 determines whether an input stop instruction is received from the input managing unit 200 (step S204). When the input stop instruction is received (Yes at step S204), the erasing unit 103 erases the data in the input buffer 110 (step S207).

On the other hand, when the input stop instruction is not received (No at step S204), the transferring unit 102 reads the data from the input buffer 110 and starts transferring the data to the memory device 130 (step S205). The transferring unit 102 waits until a transfer ending condition is fulfilled (No at step S206). The transfer ending condition means that the data transferred to the memory device 130 has reached a predetermined amount. When the transfer ending condition is fulfilled (Yes at step S206), the erasing unit 103 erases the data in the input buffer 110 (step S207).

When processings performed by the writing unit 101 and the transferring unit 102 are both completed (Yes at step S202; S207 is completed), the data processing section 100 sends an input completion notification or an input stop notification to the input managing unit 200 (step S208), and the processing ends. When an input stop instruction is received (Yes at step S204), the data processing section 100 sends an input stop notification to the input managing unit 200. When an input stop instruction is not received (No at step S204), the data processing section 100 sends an input completion notification to the input managing unit 200.

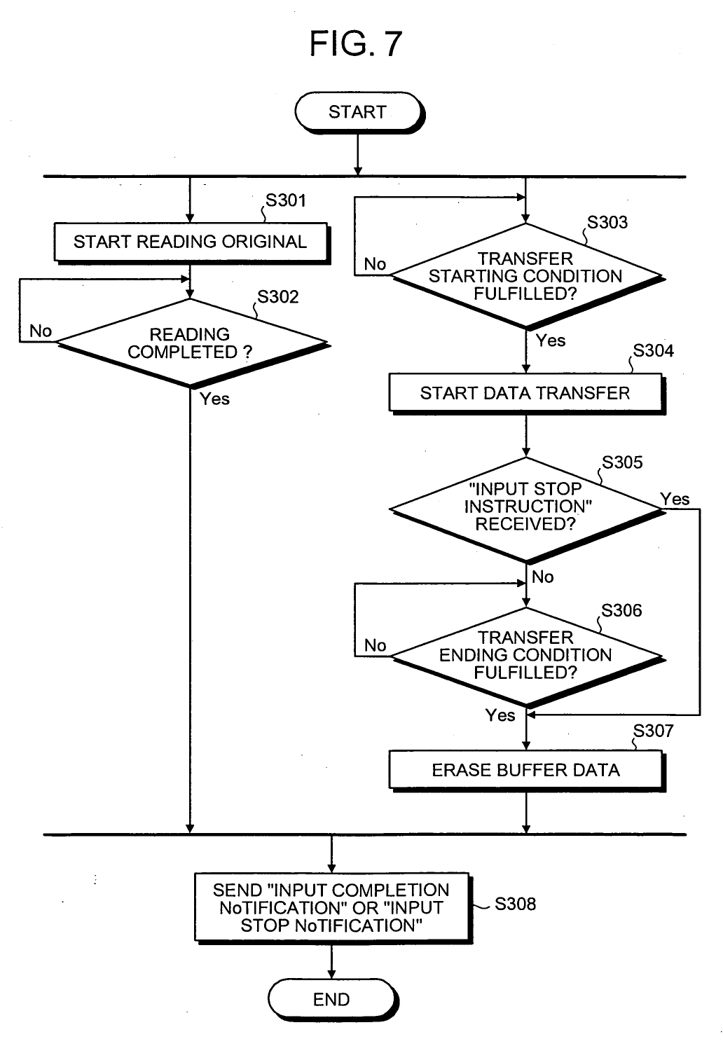

FIG. 7 is a flowchart of a processing performed by the data processing section 100. This processing is performed when the data processing section 100 receives an input stop instruction from the input managing unit 200 after starting to transfer data from the input buffer 110 to the memory device 130. The data processing section 100 performs an original reading process at steps S301 to S302, and a data transfer process from steps S303 to S307 in parallel, so that the writing unit 101 and the transferring unit 102 operate at the same time. When both processes are completed, the data processing section 100 performs step S308.

The writing unit 101 reads data of an original from the input device 120, and starts writing the data into the input buffer 110 (step S301). The writing unit 101 waits until step S301 is completed (No at step S302). When step S301 is completed (Yes at step S302), the original reading process ends.

On the other hand, the transferring unit 102 waits until a transfer starting condition is fulfilled (No at step S303). When the transfer starting condition is fulfilled (Yes at step S303), the transferring unit 102 reads data from the input buffer 110 and starts transferring the data to the memory device 130 (step S304).

The transferring unit 102 determines whether an input stop instruction is received from the input managing unit 200 (step S305). When an input stop instruction is received (Yes at step S305), the erasing unit 103 erases the data in the input buffer 110 (step S307).

On the other hand, when the input stop instruction is not received (No at step S305), the transferring unit 102 determines whether the transfer ending condition is fulfilled (step S306), and when it is not fulfilled (No at step S306), the system control returns to step S305, and repeats steps S305 and S306.

When processings performed by the writing unit 101 and the transferring unit 102 are both completed (Yes at step S302; S307 is completed), the data processing section 100 sends an input completion notification or an input stop notification to the input managing unit 200 (step S308), and the processing ends. When an input stop instruction is received (Yes at step S304), the data processing section 100 sends an input stop notification to the input managing unit 200. When an input stop instruction is not received (No at step S304), the data processing section 100 sends an input completion notification to the input managing unit 200.

According to the embodiment, the input managing unit 200 detects when an input processing is interrupted, and the input data processing section 100 erases data in the input buffer 110 when an input stop instruction is received from the input managing unit 200. Thus, data is erased from the input buffer 110 not only when data transfer to the memory device 130 is completed, but also when the input processing is interrupted. Therefore, the data remaining in the input buffer 110 is prevented from leaking.

A data-leakage prevention program executed by the image forming apparatus according to the embodiment can be stored in a computer-readable recording medium in an installable or executable format, such as a compact disc read only memory (CD-ROM), a flexible disk (FD), a CD recordable (CD-R), a digital versatile disk (DVD), and so forth. In this case, the CPU 11 reads the data-leakage prevention program from the recording medium, loads the program in the system memory 12, and causes the image forming apparatus to realize the above-described steps, units, etc.

The data-leakage prevention program can be stored in a computer connected to network such as the Internet so as to be downloaded via the network. The data-leakage prevention program can be provided or distributed through a network such as the Internet.

According to the embodiment, data is efficiently prevented from leaking from an input buffer. Furthermore, data is prevented from being erased from an input buffer by mistake when an input processing that charges a fee is not completed.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a receiving unit configured to receive image data;
a first storing unit configured to store data for a first duration;
a second storing unit configured to store data for a second duration longer than the first duration;
a writing unit configured to write the image data into the first storing unit;
a copying unit configured to copy the image data from the first storing unit to the second storing unit; and
a control unit configured to control the copying unit so as to stop copying of the image data, and erases the image data from the first storing unit when a predetermined condition is satisfied.

2. The image forming apparatus according to claim 1, wherein the control unit erases the image data from the first storing unit when the copying unit completes copying of the image data.

3. The image forming apparatus according to claim 1, wherein the condition is satisfied when a stop instruction is received.

4. The image forming apparatus according to claim 1, wherein the control unit controls writing of the image data by the writing unit.

5. The image forming apparatus according to claim 1, further comprising a charging unit that charges a fee for using the image forming apparatus, wherein
the condition is satisfied when the charging unit is in an abnormal state.

6. The image forming apparatus according to claim 5, wherein the control unit controls the writing unit so as to start writing of the image data into the first storing unit when the charging unit is in a normal state.

7. The image forming apparatus according to claim 5, wherein the control unit instructs the charging unit to charge a fee when the copying unit completes copying of the image data.

8. The image forming apparatus according to claim 1, wherein the control unit controls copying of the image data by the copying unit.

9. A computer-readable recording medium that stores therein a computer program that causes a computer to execute:
storing image data in a first storing unit that is configured to store data for a first duration;
copying the image data from the first storing unit to a second storing unit that is configured to store data for a second duration longer than the first duration; and
stopping the copying and erasing the image data from the first storing unit when a predetermined condition is satisfied.

10. A method comprising:
storing image data in a first storing unit that is configured to store data for a first duration;
copying the image data from the first storing unit to a second storing unit that is configured to store data for a second duration longer than the first duration; and
stopping the copying and erasing the image data from the first storing unit when a predetermined condition is satisfied.
